(19) United States
(12) Patent Application Publication
(10) Pub. No.: US 2009/0144805 A1
(43) Pub. Date: Jun. 4, 2009

(54) INFORMATION TRANSFER APPARATUS AND CONTROL METHOD THEREOF

(75) Inventor: Yutaka ARAKI, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/248,725

(22) Filed: Oct. 9, 2008

(30) Foreign Application Priority Data
Nov. 30, 2007 (JP) 2007-311160

(51) Int. Cl. G06F 21/00

(52) U.S. Cl. 726/2

(57) ABSTRACT

According to one embodiment, when a power source of an information transfer apparatus is turned off, information indicating termination of authentication with an AV apparatus externally connected is stored and whether or not the AV apparatus is set in a disconnected state in a power-off period is detected. Then, in a case where it is detected that the AV apparatus is not set in the disconnected state in the power-off period when the power source is turned on, a digital signal is transferred with respect to the AV apparatus based on the stored information indicating termination of authentication.

### CROSS-REFERENCE TO RELATED APPLICATIONS

This application is based upon and claims the benefit of priority from Japanese Patent Application No. 2007-311160, filed Nov. 30, 2007, the entire contents of which are incorporated herein by reference.

### BACKGROUND

1. Field

One embodiment of the invention relates to an information transfer apparatus that transfers information after performing mutual authentication with respect to an audio visual (AV) apparatus connected thereto via a digital interface, and a control method thereof.

2. Description of the Related Art

As is well known in the art, a digital visual interface (DVI) standard is widely used as a standard used to transfer video data that is converted into a digital form among a plurality of AV apparatuses. Further, in recent years, an improved high definition multimedia interface (HDMI) standard is now utilized as a digital signal transfer standard, in place of the DVI standard.

In the HDMI standard, various standards that are not contained in the DVI standard are contained. For example, as the various standards, a standard that makes it possible to multiplex digital audio data in the blanking period of digital video data and transfer audio data, a standard that makes it possible to transfer digital video data in the form of an RGB signal and in the form of a YCbCr signal or a YPbPr signal that is higher in image quality than the YPbPr signal and a standard that makes it possible to make connection by use of a universal serial bus-like (USB-like) small HDMI connector are provided.

If a digital signal is transferred by use of a digital interface in conformity to the HDMI standard, a mutual authentication process based on a high bandwidth digital protection system (HDCP) specification is performed between an AV apparatus acting as an information transmission side and an AV apparatus acting as an information reception side in order to prevent the digital signal from being dishonestly copied from the viewpoint of protection of copyright. In this case, transfer of the digital signal is permitted only when the authentication process is successfully performed.

However, in the mutual authentication process in conformity to the high bandwidth digital protection system (HDCP) specification, a time of several seconds is generally required. Therefore, even if an attempt is made to transfer a digital signal immediately after the power source is turned on to start the AV apparatus, the transfer starting time is delayed by a time required for completing the authentication process.

In Jpn. Pat. Appln. KOKAI Publication No. 2001-142839, it is disclosed that the state indicating connection or disconnection of a device with respect to an information processing apparatus is stored in a state flag at the suspend time in a system that transfers digital data from the information processing apparatus to the device connected thereto and the apparatus is started without performing the initialization routine of the device if the state flag indicates that the device is disconnected at the power-on time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block configuration diagram showing one embodiment of this invention, for schematically illustrating an information transfer system;

FIG. 2 is a block configuration diagram, for illustrating a signal processing system of a digital recording/playback apparatus configuring the information transfer system of the above embodiment;

FIG. 3 is a block configuration diagram for illustrating a signal processing system of a television receiver configuring the information transfer system of the above embodiment;

FIGS. 4A and 4B are flowcharts for illustrating the main processing operation performed by the information transfer system of the above embodiment in comparison with the conventional operation;

FIG. 5 is a flowchart for specifically illustrating one example of the interruption processing operation performed by the information transfer system of the above embodiment;

FIG. 6 is a flowchart for specifically illustrating one example of the start processing operation performed by the information transfer system of the above embodiment;

FIG. 7 is a flowchart for specifically illustrating one example of the mutual authentication processing operation performed based on the HDCP specification in the information transfer system of the above embodiment;

FIG. 8 is a flowchart for illustrating a modification of the main processing operation performed by the information transfer system of the above embodiment; and

FIG. 9 is a flowchart for specifically illustrating another example of the interruption processing operation performed by the information transfer system of the above embodiment.

### DETAILED DESCRIPTION

Various embodiments according to the invention will be described hereinafter with reference to the accompanying drawings. In general, according to one embodiment of the invention, when a power source of an information transfer apparatus is turned off, information indicating termination of authentication with an AV apparatus externally connected is stored and whether or not the AV apparatus is set in a disconnected state in a power-off period is detected. Then, in a case where it is detected that the AV apparatus is not set in the disconnected state in the power-off period when the power source is tuned on, a digital signal is transferred with respect to the AV apparatus based on the stored information indicating termination of authentication.

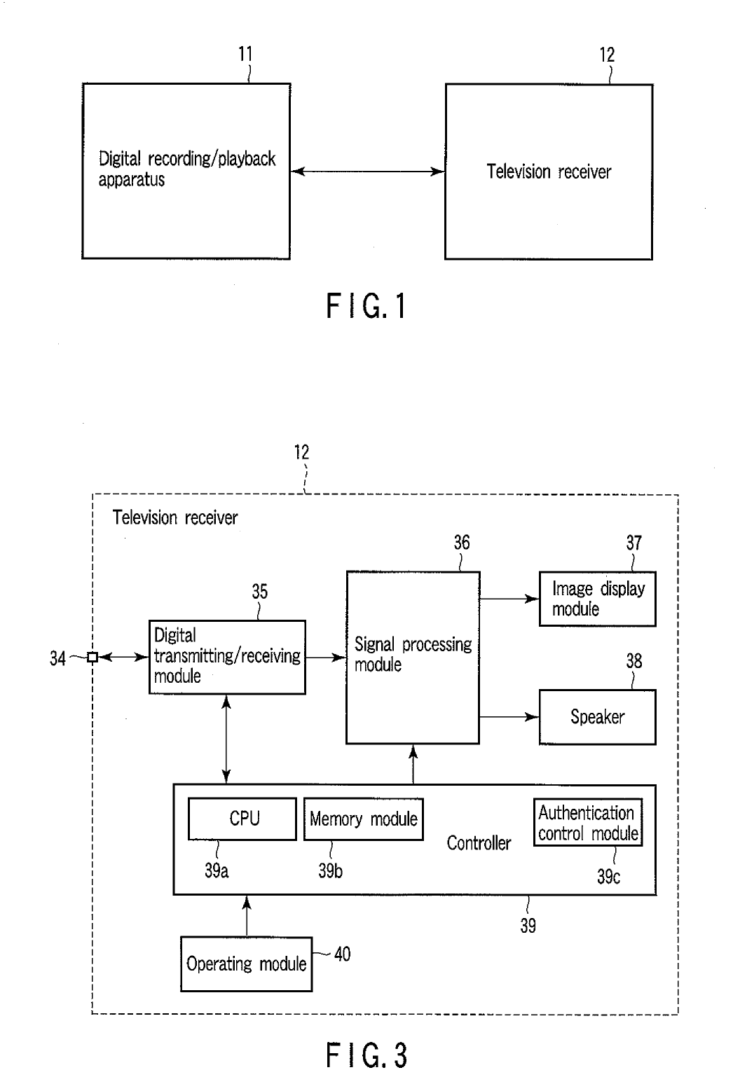

There will now be described an embodiment of the present invention with reference to the accompanying drawings. FIG. 1 schematically shows an information transfer system that will be explained in this embodiment. The information transfer system includes a digital recording/playback apparatus 11 used as an AV apparatus on the information transmission side, and a television receiver 12 used as an AV apparatus on the information reception side and connected to the apparatus via a digital interface in conformity to the HDMI standard or the like.

In the information transfer system, when the power source of the digital recording/playback apparatus 11 is turned on to start the same, it performs a mutual authentication process in conformity to the HDCP specification with respect to the television receiver 12. Then, only when the authentication process is successfully performed, transfer of a digital signal from the digital recording/playback apparatus 11 to the television receiver 12 is permitted and the image display and audio playback operations and the like of the television receiver 12 are performed.

The mutual authentication process in conformity to the HDCP specification creates a common key by use of inherent keys of the digital recording/playback apparatus 11 and television receiver 12 by exchanging the inherent keys thereof. Then, the common key created in the digital recording/playback apparatus 11 is compared with the common key created in the television receiver 12 and success of authentication is determined when the keys coincide with each other. In this case, the thus created keys are used in the encoding process of a digital signal and in the decoding process thereof.

In this case, a time of several seconds is generally required for the mutual authentication process in conformity to the HDCP specification. Therefore, a waiting time of a time period required for the authentication process occurs in a period after the digital recording/playback apparatus 11 is started by turning on the power source thereof until transfer of a digital signal to the television receiver 12 is permitted.

Therefore, in the present embodiment, information indicating that the authentication process is terminated is stored in the digital recording/playback apparatus 11 when the power source of the digital recording/playback apparatus 11 is turned off in a state in which the digital recording/playback apparatus 11 is started and an authentication process with the television receiver 12 is successfully performed. After this, in a period in which the power source of the digital recording/playback apparatus 11 is kept off, whether or not the television receiver 12 is set into a disconnected state with respect to the digital recording/playback apparatus 11 is detected.

Next, when the power source of the digital recording/playback apparatus 11 is turned on, transfer of a digital signal from the digital recording/playback apparatus 11 to the television receiver 12 is permitted by use of the previously stored information indicating termination of authentication without performing the authentication process between the digital recording/playback apparatus 11 and the television receiver 12 only if the television receiver 12 is not set in the disconnected state with the digital recording/playback apparatus 11 in the power-off period of the digital recording/playback apparatus 11.

As a result, a time period after the power source of the digital recording/playback apparatus 11 is turned on to start the same until transfer of a digital signal to the television receiver 12 is performed can be shortened and the present system can be sufficiently suited to practical use.

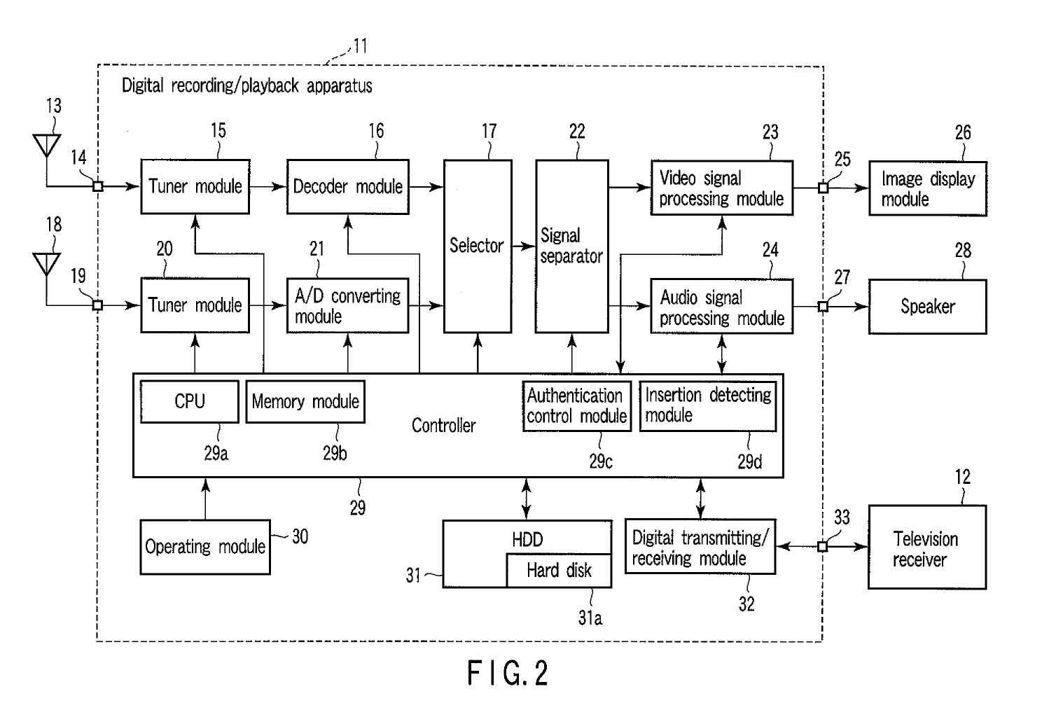

FIG. 2 shows a signal processing system of the digital recording/playback apparatus 11. In FIG. 2, a symbol 13 denotes a digital broadcast receiving antenna. A digital broadcast signal received by the antenna 13 is supplied to a tuner potion 15 via an input terminal 14.

The tuner potion 15 selects a desired channel signal from the input digital broadcast signal. A signal output from the tuner module 15 is supplied to a decoder module 16, subjected to, for example, a moving picture experts group (MPEG) 2 decode process, and then supplied to a selector 17.

Further, an analog broadcast signal received by an analog broadcast signal receiving antenna 18 is supplied to a tuner module 20 via an input terminal 19. The tuner module 20 selects a desired channel signal from the input analog broadcast signal. A signal output from the tuner module 20 is converted into a digital form by an analog/digital (A/D) converting module 21 and then supplied to the selector 17.

The selector 17 selects one of the digital signals output from the decoder module 16 and A/D converting module 21 and supplies the selected signal to a signal separator 22. The signal separator 22 separates the input digital signal into a video component and audio component, supplies a digital video signal to a video signal processing module 23 and supplies a digital audio signal to an audio signal processing module 24.

The video signal processing module 23 subjects the input digital video signal among the above input signals to a preset signal process including an error correction process, a decoding process and the like to generate an analog video signal. Then, the analog video signal output from the video signal processing module 23 is supplied to an external image display module 26 via an image output terminal 25 and used for image display.

Further, the audio signal processing module 24 subjects the input digital audio signal to a preset signal process including an error correction process, a decoding process and the like to generate an analog audio signal. Then, the analog audio signal output from the audio signal processing module 24 is supplied to an external speaker 28 via an audio output terminal 27 and used for audio playback.

In this case, all of the operations, including the various reception operations described above, are controlled by a controller 29 in the digital recording/playback apparatus 11. The controller 29 contains a central processing unit (CPU) 29a, receives operation information from an operating module 30 and controls the respective modules to reflect the operation contents.

In this case, the controller 29 utilizes a memory module 29b. The memory module 29b mainly includes a read only memory (ROM) in which a control program executed by the CPU 29a is stored, a random access memory (RAM) used to provide a working area for the CPU 29a and a nonvolatile memory in which various setting information items, control information and the like are stored.

Further, an HDD 31 is connected to the controller 29. The controller 29 can perform a control operation to supply a digital video signal output from the video signal processing module 23 and a digital audio signal output from the audio signal processing module 24 to the HDD 31 and store the same into a hard disk 31a based on the operation of the operating module 30 by the user.

Also, the controller 29 can perform a control operation to cause the HDD 31 to read out a video signal and audio signal output from the hard disk 31a, respectively supply them to the video signal processing module 23 and audio signal processing module 24 and use them for image display and audio playback based on the operation of the operating module 30 by the user.

Further, a digital transmitting/receiving module 32 is connected to the controller 29. The digital transmitting/receiving module 32 has a digital interface function in conformity to the HDMI standard, which makes it possible to perform data transfer between the controller 29 and the AV apparatus (in this example, the television receiver 12) connected to an input/output terminal 33. In this case, the digital transmitting/receiving module 32 subjects a to-be-transmitted digital signal to an encoding process in conformity to the HDCP specification and subjects a received digital signal to a decoding process.

As a result, the controller 29 can transmit a control signal to the television receiver 12 via the digital transmitting/receiving module 32 and input/output terminal 33 and control the television receiver 12 to operate in a preset operation state. Therefore, the controller 29 can play back the video signal and audio signal recorded in the hard disk 31a of the HDD 31, transmit the thus played-back video signal and audio signal to the television receiver 12 via the digital transmitting/receiving module 32 and input/output terminal 33 and use them for image display and audio playback.

The controller 29 further includes an authentication control module 29c that performs a mutual authentication process in conformity to the HDCP specification with respect to the AV apparatus (in this example, the television receiver 12) connected to the input/output terminal 33. Further, the controller 29 includes an insertion detecting module 29d that detects whether or not the television receiver 12 is disconnected from the input/output terminal 33, that is, whether an HDMI plug (not shown) is inserted into or removed from the input/output terminal 33.

Further, the controller 29 is kept energized irrespective of the on/off state of a power source switch (not shown) contained in the operating module 30.

FIG. 3 shows a signal processing system of the television receiver 12. In FIG. 3, a symbol 34 denotes an input/output terminal that is connected to the input/output terminal 33 of the digital recording/playback apparatus 11. The input/output terminal 34 is connected to a digital transmitting/receiving module 35. The digital transmitting/receiving module 35 has a digital interface function in conformity to the HDMI standard and performs data transfer with respect to the controller 29 of the digital recording/playback apparatus 11. In this case, the digital transmitting/receiving module 35 subjects a to-be-transmitted digital signal to an encoding process based on the HDCP specification and subjects a received digital signal to a decoding process.

As a result, a digital signal output from the input/output terminal 33 of the digital recording/playback apparatus 11 is supplied to the digital transmitting/receiving module 35 via the input/output terminal 34 and subjected to the decoding process. Then, signals corresponding to the video component and audio component in the digital signal subjected to the decoding process by the digital transmitting/receiving module 35 are supplied to a signal processing module 36, separated into a video signal and audio signal, respectively supplied to an image display module 37 and speaker 38 and used for image display and audio playback.

At this time, various operations, including the video display and audio playback operations described above in the television receiver 12, are controlled by means of a controller 39. The controller 39 contains a CPU 39a, receives operation information from an operating module 40 or a control signal in the digital signal subjected to the decoding process in the digital transmitting/receiving module 35 and controls the respective modules to reflect the operation contents and control contents.

In this case, the controller 39 utilizes a memory module 39b. The memory module 39b mainly includes a ROM in which a control program executed by the CPU 39a is stored, a RAM used to provide a working area for the CPU 39a and a nonvolatile memory in which various setting information items, control information and the like are stored.

Further, the controller 39 includes an authentication control module 39c that performs a mutual authentication process in conformity to the HDCP specification with respect to the AV apparatus (in this example, the digital recording/playback apparatus 11) connected to the input/output terminal 34.

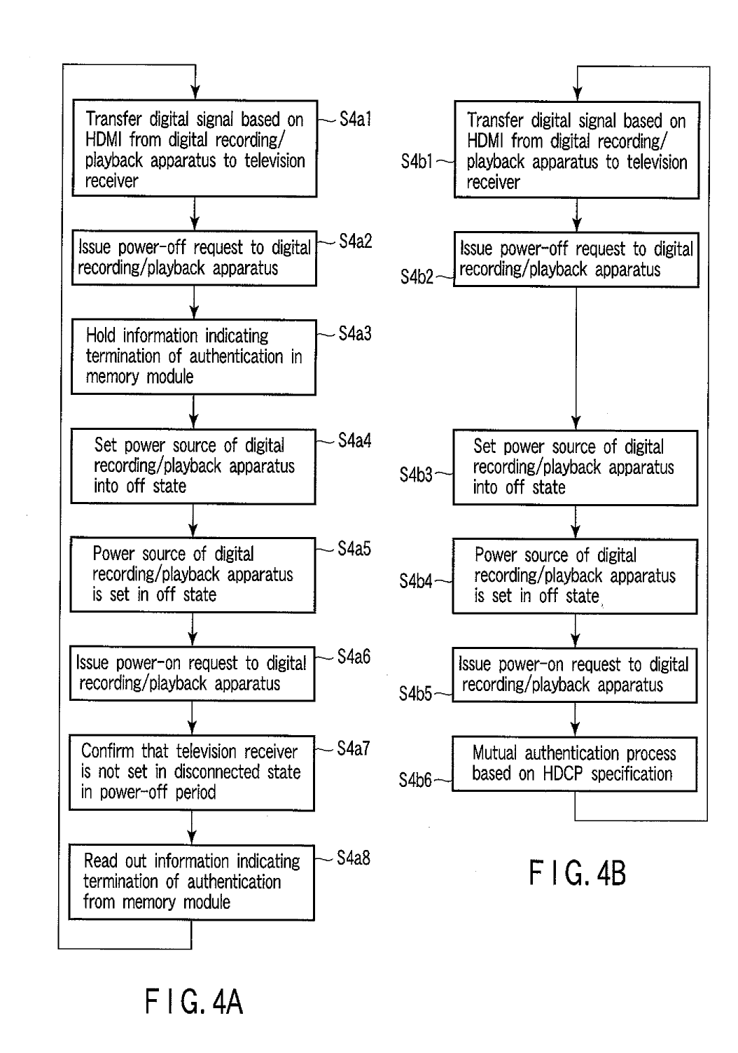

FIG. 4A is a flowchart for illustrating the processing operation of the information transfer system according to this embodiment. Further, FIG. 4B is a flowchart for illustrating the conventional processing operation in comparison with the processing operation of the information transfer system according to this embodiment.

First, in the conventional processing operation shown in FIG. 4B, when a request to turn on the power source is supplied to the digital recording/playback apparatus 11 (step S4b5), the controller 29 of the digital recording/playback apparatus 11 performs a mutual authentication process based on the HDCP specification with respect to the television receiver 12 (step S4b6). If the authentication process is successfully performed, the controller 29 transfers a video signal and audio signal in a form that conforms to the HDMI standard to the television receiver 12 (step S4b1).

After this, the controller 29 sets the power source of the digital recording/playback apparatus 11 into an off state (step S4b3) when a request to turn off the power source is supplied to the digital recording/playback apparatus 11 (step S4b2). Then, the controller is set in a waiting state to wait until the power source is turned on (step S4b4). Therefore, a waiting time of the time period required for the mutual authentication process occurs in a period after the power source of the digital recording/playback apparatus 11 is turned on until transfer of a digital signal to the television receiver 12 is started.

On the other hand, in the processing operation of the present embodiment shown in FIG. 4A, it is assumed that a request to turn off the power source is supplied to the digital recording/playback apparatus 11 (step S4a2) in a state in which the mutual authentication process is successfully performed between the digital recording/playback apparatus 11 and the television receiver 12 and a video signal and audio signal are transferred in a form that conforms to the HDMI standard from the digital recording/playback apparatus 11 to the television receiver 12 (step S4a1). Then, the controller 29 of the digital recording/playback apparatus 11 writes and holds information indicating termination of authentication with respect to the television receiver 12 in a nonvolatile memory or the like of the memory module 29b (step S4a3), sets the power source of the digital recording/playback apparatus 11 into the off state (step S4a4) and is set into a waiting state to wait until the power source is turned on (step S4a5).

In a case where the controller 29 of the digital recording/playback apparatus 11 can confirm that the television receiver 12 is not set in a disconnected state by means of the insertion detecting module 29d in a power-off period (step S4a7) when a request to turn on the power source is supplied to the digital recording/playback apparatus 11 (step S4a6), the information indicating termination of authentication held in the memory module 29b is read out (step S4a8). Then, a digital signal is transferred from the digital recording/playback apparatus 11 to the television receiver 12 by use of the read information (step S4a1).

According to the above embodiment, information indicating termination of authentication with respect to the television receiver 12 is held in the memory module 29b when the power source of the digital recording/playback apparatus 11 is turned off. Further, when the power source of the digital recording/playback apparatus 11 is turned on and only in a case where the television receiver 12 is not set in the disconnected state in the power-off period of the digital recording/playback apparatus 11, transfer of a digital signal from the digital recording/playback apparatus 11 to the television receiver 12 is permitted by use of the authentication-termination information held in the memory module.

That is, if the television receiver 12 is not set in the disconnected state in the power-off period of the digital recording/playback apparatus 11, the mutual authentication process with respect to the television receiver 12 is omitted and transfer of a digital signal to the television receiver 12 can be performed when the power source of the digital recording/playback apparatus 11 is turned on. Therefore, a time period after the power source of the digital recording/playback apparatus 11 is turned on until transfer of a digital signal to the television receiver 12 is started can be shortened.

When the insertion detecting module 29d detects that the television receiver 12 is set into the disconnected state in the power-off period of the digital recording/playback apparatus 11, change of the connection relation, that is, connection of an AV apparatus other than the television receiver 12 that has been connected is predicted. Since an inherent key used according to the HDCP specification is changed if the connection relation is changed, it becomes necessary to perform the mutual authentication process.

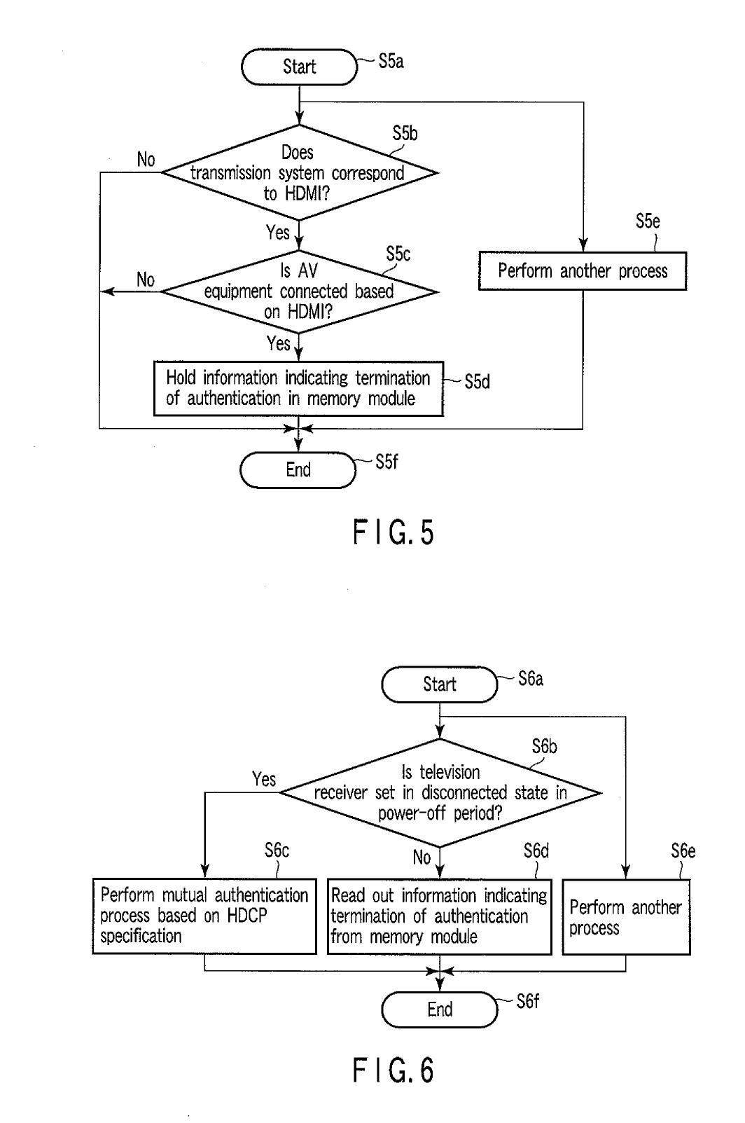

FIG. 5 shows one example of a processing operation of writing and holding information that indicates termination of authentication between the digital recording/playback apparatus 11 and the television receiver 12 into the memory module 29b in the step S4a3. The process is started by issuing a request to turn off the power source to the digital recording/playback apparatus 11 (step S5a).

Then, the controller 29 determines, in the step S5b, whether or not the transmission system of a digital signal is a system that conforms to the HDMI standard. If it is determined that the transmission system corresponds to the HDMI standard (YES), the controller 29 determines, in the step S5c, whether or not the controller is actually connected to an external AV apparatus in a form corresponding to the HDMI standard.

If it is determined that the controller is actually connected to an external AV apparatus in a form corresponding to the HDMI standard (YES), the controller 29 writes and holds information indicating that authentication with the television receiver 12 has been terminated into the nonvolatile memory of the memory module 29b in the step S5d and then terminates the process (step S5f).

If it is determined in the step S5b that the transmission system of the digital signal does not correspond to the HDMI standard (NO) or if it is determined in the step S5c that the controller is not actually connected to the external AV apparatus in a form that conforms to the HDMI standard (NO), the controller 29 terminates the process as it is (step S5f).

Further, when the process is started in the step S5a, the controller 29 performs various processes (for example, including a suspend process) to be performed when the power source of the digital recording/playback apparatus 11 is turned off in the step S5e in parallel with the process of the steps S5b to S5d and then terminates the process (step S5f).

FIG. 6 shows one example of a processing operation of reading out information indicating termination of authentication held in the memory module 29b when it is determined that the television receiver 12 is not set in the disconnected state by means of the insertion detecting module 29d in the power-off period in the steps S4a7 and S4a8. The process is started by issuing a request to turn on the power source to the digital recording/playback apparatus 11 (step S6a).

Then, the controller 29 determines in the step S6b whether or not the television receiver 12 is set in the disconnected state with respect to the input/output terminal 33 in a period in which the power source of the digital recording/playback apparatus 11 is kept set in the off state. The determination process is performed based on the detection result of the insertion detecting module 29d and can be realized by activating the controller 29 in a period in which the power source of the digital recording/playback apparatus 11 is kept set in the off state.

When it is determined that the television receiver 12 is set in the disconnected state with respect to the input/output terminal 33 (YES), the controller 29 performs a mutual authentication process with respect to the AV apparatus connected to the input/output terminal 33 in the step S6c and then terminates the process (step S6f).

If it is determined in the step S6b that the television receiver 12 is not set in the disconnected state with respect to the input/output terminal 33 (NO), the controller 29 reads out information indicating termination of authentication from the nonvolatile memory of the memory module 29b in the step S6d and terminates the process (step S6f). In the process of the step S6d, it can be regarded that an authentication process based on the HDCP specification is successfully performed by acquiring the common key from the memory module 29b.

Further, when the process is started in the step S6a, the controller 29 performs various processes to be performed when the power source of the digital recording/playback apparatus 11 is turned on in the step S6e in parallel with the process of the steps S6b to S6d and then terminates the process (step S6f).

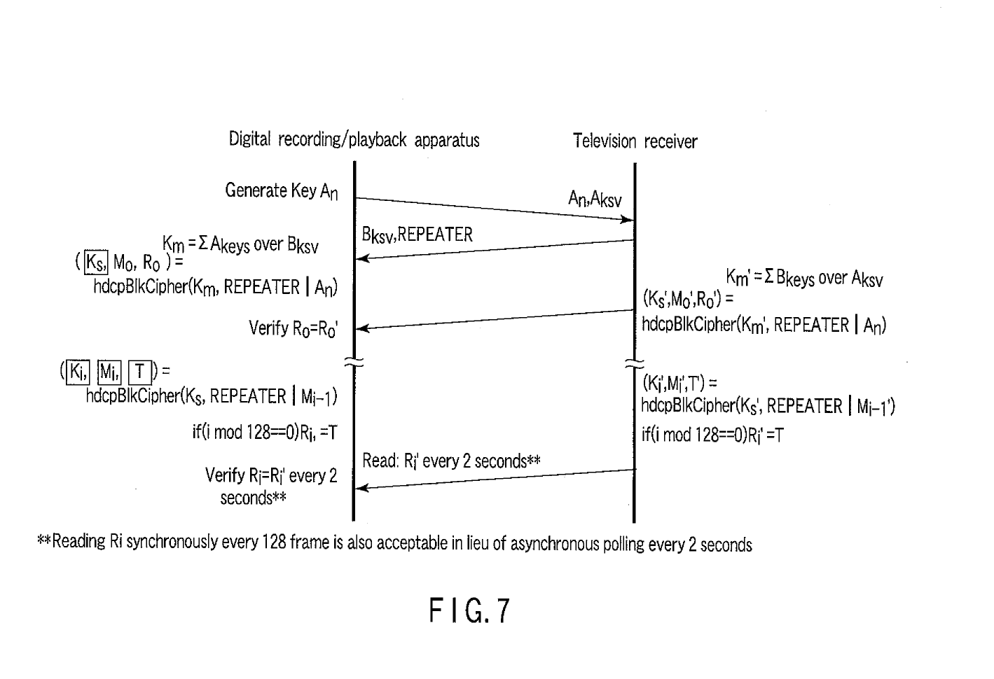

FIG. 7 shows a mutual authentication processing operation based on the HDCP specification. That is, in the digital recording/playback apparatus 11, a random key An is created and transmitted to the television receiver 12 together with a key Aksv. Then, in the digital recording/playback apparatus 11, keys Ks, Mo, Ro are created based on Bksv and RPEATER acquired from the television receiver 12 and the authentication process is performed by comparing Ro with Ro′ similarly created in the television receiver 12.

After this, keys Ki, Mi, T are created for each video frame in the digital recording/playback apparatus 11 and television receiver 12 and it is determined that the television receiver 12 is an AV apparatus that has been authenticated by comparing the keys T for every 128 frames. In the authentication process, keys Ks, Ki, Mi, T surrounded by squares are used as common keys and held in the memory module 29b when the power source of the digital recording/playback apparatus 11 is turned off.

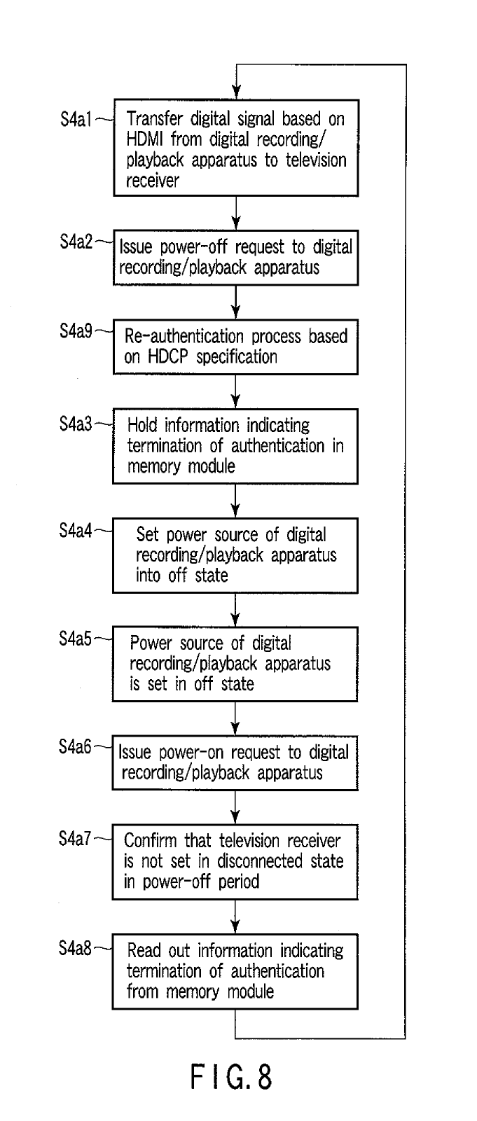

FIG. 8 shows a modification of the processing operation previously shown in FIG. 4A. In FIG. 8, modules that are the same as those of FIG. 4A are denoted by the same symbols, and an explanation thereof is not made. When a request to turn off the power source is issued to the digital recording/playback apparatus 11 in the step S4a2, the controller 29 of the digital recording/playback apparatus 11 performs a mutual authentication process based on the HDCP specification with respect to the television receiver 12 (step S4a9) and writes and holds common keys created in the authentication process in the nonvolatile memory of the memory module 29b in the step S4a3.

That is, when a request to turn off the power source is issued to the digital recording/playback apparatus 11, the mutual authentication process based on the HDCP specification is performed again to update the common key in a case where the common key is held in the memory module 29b. Then, the updated common key is held in the memory module 29b to enhance the security. In this case, since the power source of the digital recording/playback apparatus 11 is kept in the off state, no problem occurs for the user even if a certain time is required for the authentication process.

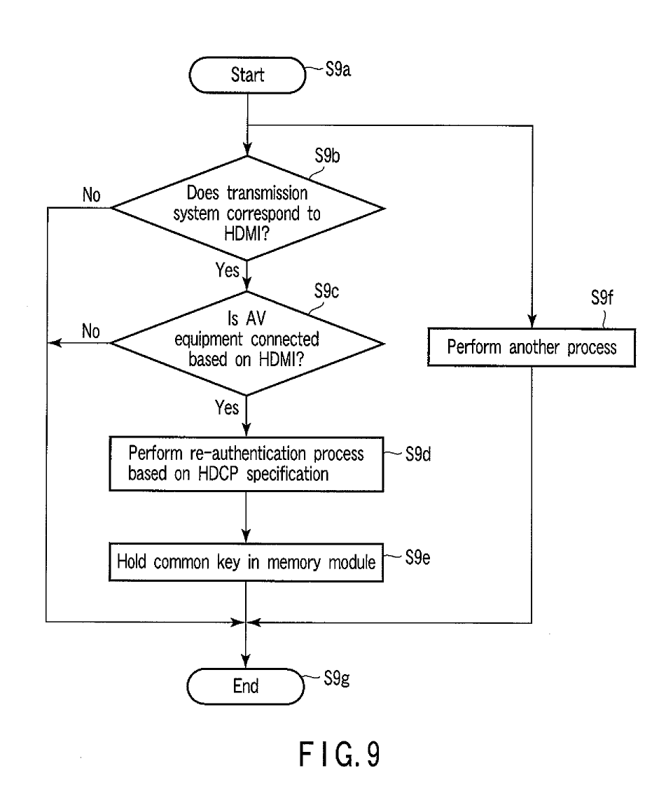

FIG. 9 shows one example of a processing operation of performing a re-authentication process with respect to the television receiver 12 when the power source of the digital recording/playback apparatus 11 is turned off in the steps S4a9 and S4a3 and writing and holding the common key in the memory module 29b. The process is started by issuing a request to turn off the power source to the digital recording/playback apparatus 11 (step S9a).

Then, the controller 29 determines in the step S9b whether or not the transmission system of a digital signal is a system that conforms to the HDMI standard. If it is determined that the transmission system corresponds to the HDMI standard (YES), the controller 29 determines in the step S9c whether or not the controller 29 is actually connected to an external AV apparatus in a form that conforms to the HDMI standard.

If it is determined that the controller is actually connected to an external AV apparatus in a form corresponding to the HDMI standard (YES), the controller 29 performs a mutual authentication process with respect to the television receiver 12 based on the HDCP specification in the step S9d, writes and holds a common key acquired in the authentication process as information that indicates termination of authentication into the nonvolatile memory of the memory module 29b in the step S9e and then terminates the process (step S9g).

If it is determined in the step S9b that the transmission system of the digital signal does not correspond to the HDMI standard (NO) or if it is determined in the step S9c that the controller is not actually connected to an external AV apparatus in a form corresponding to the HDMI standard (NO), the controller 29 terminates the process as it is (step S9g).

Further, when the process is started in the step S9a, the controller 29 performs various processes (for example, including a suspend process) to be performed when the power source of the digital recording/playback apparatus 11 is turned off in the step S9f in parallel with the process of the steps S9b to S9e and then terminates the process (step S9g).

In the above embodiment, the AV apparatus on the information transmission side (in this example, the digital recording/playback apparatus 11) is explained. However, for the AV apparatus on the information reception side (in this case, the television receiver 12), the mutual authentication process based on the HDCP specification at the power-on time may be omitted by performing the same processes as those shown in FIGS. 5 and 6 and a time period from the starting time of power-on until image display is performed can be shortened.

Further, in this embodiment, the HDMI standard is used as the digital transmission system. However, this is not limitative and, for example, in a standard in which video contents are transmitted or received by use of a digital signal as in the DVI standard, an encoding process for protection of the contents is required. Therefore, this invention can be applied to the above standards. Likewise, this invention can be applied not only to HDCP but also another encoding protocol such as DTCP.

Further, as in the above embodiment, this invention can be applied to a case wherein an encoding process is required not only in transmission/reception of video contents between the digital recording/playback apparatus 11 and the television receiver 12 but also in transmission/reception of audio contents or data contents by use of another AV apparatus.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information transfer apparatus configured to transfer a digital signal after performing a mutual authentication process with an Audio/Visual (AV) apparatus connected to the information transfer apparatus via a digital interface, comprising:
a storage module configured to store information indicating termination of authentication with the AV apparatus when a power source is turned off in a state in which the mutual authentication process with the AV apparatus is completed,
a detecting module configured to detect whether the AV apparatus is set to a disconnected state in a power-off period, and
a controller configured to transfer a digital signal to the AV apparatus based on the information indicating termination of authentication held in the storage module if the detecting module detects that the AV apparatus is not set in the disconnected state in the power-off period when the power source is turned on.

2. The information transfer apparatus of claim 1, wherein the controller is configured to perform a mutual authentication process with the AV apparatus connected to the information transfer apparatus via the digital interface if the detecting module detects that the AV apparatus is set in the disconnected state in the power-off period when the power source is turned on.

3. The information transfer apparatus of claim 1, wherein the storage module is configured to store information indicating termination of authentication with the AV apparatus if a transfer system of the digital signal corresponds to the digital interface and the AV apparatus is connected to the digital interface when the power source is turned off in a state in which the mutual authentication process with the AV apparatus is completed.

4. The information transfer apparatus of claim 1, wherein the storage module is configured to perform a re-authentication process with the AV apparatus and to store information indicating termination of authentication for the re-authentication process when the power source is turned off in a state in which the mutual authentication process with the AV apparatus is completed.

5. The information transfer apparatus of claim 1, wherein the digital interface is a transfer system corresponding to an HDMI standard and the mutual authentication process with the AV apparatus is performed in a form corresponding to a High-bandwidth Digital Content Protection (HDCP) specification.

6. The information transfer apparatus of claim 5, wherein the information indicating termination of authentication held in the storage module is a common key used in the authentication process corresponding to the HDCP specification.

7. The information transfer apparatus of claim 5, wherein the detecting module is configured to detect insertion of an HDMI plug used to connect the AV apparatus.

8. A control method of an information transfer apparatus for controlling the information transfer apparatus configured to transfer a digital signal after performing a mutual authentication process with an AV apparatus connected to the information transfer apparatus via a digital interface, comprising:
storing information indicating termination of authentication with the AV apparatus when a power source is turned off in a state in which the mutual authentication process with the AV apparatus is completed,
detecting whether the AV apparatus is set to a disconnected state in a power-off period, and
performing a control operation to transfer a digital signal to the AV apparatus based on the stored information indicating termination of authentication if it is detected that the AV apparatus is not set in the disconnected state in the power-off period when the power source is turned on.

9. The control method of the information transfer apparatus of claim 8, wherein the performing the control operation is performing a mutual authentication process with an AV apparatus connected via the digital interface if it is detected that the AV apparatus is set in the disconnected state in the power-off period when the power source is turned on.

10. The control method of the information transfer apparatus of claim 8, wherein the storing is storing information indicating termination of authentication with the AV apparatus if a transfer system of the digital signal corresponds to the digital interface and the AV apparatus is connected to the digital interface when the power source is turned off in a state in which the mutual authentication process with the AV apparatus is completed.

11. The control method of the information transfer apparatus of claim 8, wherein the storing is performing a re-authentication process with the AV apparatus and storing information indicating termination of authentication for the re-authentication process when the power source is turned off in a state in which the mutual authentication process with the AV apparatus is completed.
